(19) United States
(12) Patent Application Publication
(10) Pub. No.: US 2023/0387993 A1
(43) Pub. Date: Nov. 30, 2023

(54) CSI FEEDBACK FOR MULTI-TRP DL TRANSMISSION

(71) Applicant: LENOVO (BEIJING) LIMITED, Beijing (CN)

(72) Inventors: Bingchao LIU, Beijing (CN); Chenxi ZHU, Fairfax, VA (US); Wei LING, Beijing (CN); Yi ZHANG, Beijing (CN)

(21) Appl. No.: 18/249,692

(22) PCT Filed: Oct. 23, 2020
(86) PCT No.: PCT/CN2020/123113

§ 371 Date: Apr. 19, 2023

(51) Int. Cl. H04B 7/06; H04L 5/00; H04W 24/10; H04W 72/20

(52) U.S. Cl. CPC H04B 7/0626; H04W 72/20; H04W 24/10; H04L 5/0053

(57) ABSTRACT

Methods and apparatuses for reporting CSI for single-DCI based multi-TRP PDSCH transmission are disclosed. In one embodiment, a method comprises receiving a configuration indicating that two CSI reportings are associated with each other; receiving a DCI containing a CSI request field with a non-zero value that simultaneously triggers two CSI reports by associating the non-zero value to the associated two CSI reportings; and transmitting the two CSI reports in a same slot.

### FIELD

The subject matter disclosed herein generally relates to wireless communications, and more particularly relates to methods and apparatuses for reporting CSI for single-DCI based multi-TRP DL transmission.

### BACKGROUND

The following abbreviations are herewith defined, at least some of which are referred to within the following description: Third Generation Partnership Project (3GPP), European Telecommunications Standards Institute (ETSI), Frequency Division Duplex (FDD), Frequency Division Multiple Access (FDMA), Long Term Evolution (LTE), New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), Personal Digital Assistant (PDA), User Equipment (UE), Uplink (UL), Evolved Node B (eNB), Next Generation Node B (gNB), Downlink (DL), Central Processing Unit (CPU), Graphics Processing Unit (GPU), Field Programmable Gate Array (FPGA), Dynamic RAM (DRAM), Synchronous Dynamic RAM (SDRAM), Static RAM (SRAM), Liquid Crystal Display (LCD), Light Emitting Diode (LED), Organic LED (OLED), Orthogonal Frequency Division Multiplexing (OFDM), Radio Resource Control (RRC), Time-Division Duplex (TDD), Time Division Multiplex (TDM), User Entity/Equipment (Mobile Terminal) (UE), Uplink (UL), Universal Mobile Telecommunications System (UMTS), Physical Downlink Shared Channel (PDSCH), Physical Uplink Shared Channel (PUSCH), Physical Uplink Control Channel (PUCCH), Downlink control information (DCI), Single-DCI (S-DCI), transmission reception point (TRP), multiple TRP (multi-TRP or M-TRP), Quasi Co-Location (QCL), channel state information (CSI), channel state information reference signal (CSI-RS), Transmission Configuration Indication (TCI), reference signal (RS), Media Access Control (MAC), Control Element (CE), Demodulation Reference Signal (DM-RS), non-coherent joint transmission (NCJT), frequency range (FR), CSI-RS resource indicator (CRI), rank indicator (RI), precoding matrix indicator (PMI), layer indicator (LI), channel quality indicator (CQI), Non-Zero Power (NZP), Zero Power (ZP), Information Element (IE), enhanced Mobile Broadband (eMBB), Ultra Reliable Low Latency Communication (URLLC), Space Division Multiplexing (SDM), Frequency Division Multiplexing (FDM), Time Division Multiplexing (TDM), Frequency Range 2 (FR2), resource block (RB), bandwidth part (BWP), channel measurement resource (CMR), interference measurement resource (IMR), channel state information interference measurement (CSI-IM).

In NR Release 15, the CSI feedback framework is designed for single-TRP scenario, where signals from a different TRP can only be treated as interference in one CSI reporting for one TRP. Channel state information reference signal (CSI-RS) is used for measuring DL channels. UE receives CSI-RS resources to perform DL channel measurement and may report the result of the measurement to gNB (the base station). A CSI-ReportConfig IE configured by RRC signaling is a CSI report setting to notify the UE the quantities (parameters) to be reported, the resources to be measured and the reporting manner.

In NR Release 15, a CSI-ReportConfig (CSI reporting) is linked to one Resource Setting for channel measurement which may have multiple resource sets each of which may include one or more CSI-RS resources. One or more CSI-RS resource sets selected from the Resource Setting are linked with one CSI-ReportConfig. From the UE point of view, the CSI-RS resources included in the linked CSI-RS resource set(s) are to be received by the UE for the channel measurement. For example, an aperiodic CSI report is triggered by a DCI, and in particular, a ‘CSI request’ field of the DCI. A non-zero value of the CSI request field (i.e. non-zero CSI request field value, which is referred to as a trigger state) is associated with one or more CSI-ReportConfig configured by a higher layer parameter CSI-AperiodicTriggerState.

A higher layer parameter reportQuantity contained in CSI-ReportConfig IE configures the UE with the CSI quantities (parameters) to be reported in a CSI report. The parameters may include but not limited to CSI-RS resource indicator (CRI), rank indicator (RI), precoding matrix indicator (PMI), layer indicator (LI) and channel quality indicator (CQI). The parameters are determined and calculated by the UE based on the received CSI-RS resources linked to the CSI-ReportConfig.

CRI is used to indicate a CSI-RS resource to derive the corresponding CSI parameter(s). That is, CRI is used to indicate one CSI-RS resource from the CSI-RS resources included in the linked CSI-RS resource set(s) in the Resource Setting.

RI is used to indicate the maximum number of DL layers that can be supported for the received CSI-RS resource indicated by CRI.

PMI is used to indicate the best precoding matrix suitable for the received CSI-RS resource indicated by CRI with the rank indicated by RI.

LI indicates which column of the precoder matrix of the reported PMI corresponds to the strongest layer of the codeword corresponding to the largest reported wideband CQI. If two wideband CQIs are reported and have equal value, the LI corresponds to strongest layer of the first codeword.

CQI is used to indicate how good or bad the communication channel quality is.

As a whole, when one CSI report is triggered by a DCI containing a CSI request field with a non-zero value by associating the non-zero value to one CSI reporting, quantities (parameters) to be reported and the values of the reported quantities included in the one CSI report are determined and calculated based on the one CSI reporting.

Single-DCI (S-DCI) based multi-TRP DL transmission is supported in NR Release 16, especially for eMBB and URLLC traffic. Different schemes can be assumed: SDM scheme, FDM scheme and TDM scheme.

FIG. 1 illustrates an example of PDSCH transmission for non-coherent joint transmission (NCJT) for eMBB, when SDM or FDM scheme is assumed. A DCI transmitted by any of TRP #1 or TRP #2 schedules a PDSCH transmission transmitted from different TRPs (e.g. from both TRP #1 and TRP #2) using two different TX beams in FR2 (FR2 indicates a frequency band from 24.25 GHz to 52.6 GHz), where each TRP transmits partial layer(s) of the PDSCH transmission. It means that a UE can receive a PDSCH transmission simultaneously transmitted from two TRPs with two different RX beams in FR2. If SDM scheme is assumed, different PDSCH layers are transmitted by different TRPs using the same RBs. If FDM scheme is assumed, different PDSCH layers are transmitted by different TRPs using different RBs in the same slot. For example, as shown in FIG. 1, in SDM or FDM scheme, layer 1 of PDSCH transmission #1 is transmitted from TRP #1 with Tx beam #1 and received by UE with Rx beam #1, and layer 2 of PDSCH transmission #1 is transmitted from TRP #2 with Tx beam #2 and received by UE with Rx beam #2. It can be seen that the UE is required to have the capability of simultaneously receiving different TX beams transmitted by TRP #1 and TRP #2 for SDM and FDM schemes.

FIG. 2 illustrates an example of PDSCH transmission when TDM scheme is assumed. A DCI transmitted by any of TRP #1 or TRP #2 schedules a PDSCH transmission with repetition transmitted from different TRPs (e.g. from both TRP #1 and TRP #2) using two different TX beams in FR2. The scheduled PDSCH is transmitted two times by different TRPs (e.g. TRP #1 and TRP #2) in different time slots, i.e., slot n and slot n+1, using different TX beams in FR2. That is, PDSCH transmission #1 is transmitted from TRP #1 with Tx beam #1 in time slots n and received by UE with Rx beam #1, and PDSCH transmission #1 is transmitted from TRP #2 with Tx beam #2 in time slots n+1 and received by UE with Rx beam #2. It can be seen that the UE is not required to have the capability of simultaneously receiving different TX beams transmitted by TRP #1 and TRP #2 for TDM scheme.

According to NR Release 16 CSI feedback framework, the CSI-RS resources for channel measurement cannot be simultaneously transmitted with different beams to a UE. In addition, the inter-TRP coordination (e.g. the coordination between two TRPs) can only be treated as an interference measured based NZP CSI-RS resources with determined layers. In this condition, the reported CSI cannot well match the non-coherent joint PDSCH transmission by different TRPs.

Different interference hypothesis should be made for different schemes (e.g. SDM, FDM, TDM). For example, inter-TRP interference should be well modeled when SDM scheme is assumed. The CSI conducted in different sub-bands for FDM and CSI conducted in different time slots for TDM scheme should be jointly considered for corresponding PDSCH scheduling. The gNB cannot obtain the perfect CSI for NCJT scheduling according to Release 16 CSI feedback framework.

This invention discloses methods and apparatuses for reporting CSI for single-DCI based multi-TRP PDSCH transmission with any of SDM, FDM and TDM schemes.

### BRIEF SUMMARY

Methods and apparatuses for reporting CSI for single-DCI based multi-TRP PDSCH transmission are disclosed.

In one embodiment, a method comprises receiving a configuration indicating that two CSI reportings are associated with each other; receiving a DCI containing a CSI request field with a non-zero value that simultaneously triggers two CSI reports by associating the non-zero value to the associated two CSI reportings; and transmitting the two CSI reports in a same slot.

In one embodiment, the configuration may be received by RRC signaling or by a MAC CE. Preferably, the same codebook configuration and the same codebook subset restriction are configured for the associated two CSI reportings. When K CSI-RS resources are configured within a resource setting for channel measurement of each of the associated two CSI reportings, K CPUs are occupied by the two CSI reports from a slot receiving the DCI to the same slot transmitting a PUCCH or PUSCH resource carrying the two CSI reports.

In another embodiment, each of NZP CSI-RS resources within a resource setting for channel measurement of one CSI reporting in the associated two CSI reportings are 1-to-1 associated with each of NZP CSI-RS resources within a resource setting for channel measurement of another CSI reporting in the associated two CSI reportings, and the associated NZP CSI-RS resources can be simultaneously received in a same symbol when SDM or FDM scheme is assumed. If NZP CSI-RS based interference measurement is configured for the associated two CSI reportings, NZP-CSI-RS resources within resource settings for interference measurement of the associated two CSI reportings associated with the paired NZP CSI-RS resources for channel measurement are considered in the interference calculation in each of the two CSI reports. If ZP CSI-RS based interference measurement is configured for the associated two CSI reportings, the same ZP CSI-RS pattern is configured for the associated two CSI reportings. When SDM scheme is assumed, the interference between associated NZP CSI-RS resources for channel measurement is not considered as the interference for UE with interference suppression capability, and is considered as the interference for UE without interference suppression capability. When FDM scheme is assumed, the interference between associated NZP CSI-RS resources is not considered as the interference for UE.

In some embodiment, when SDM scheme is assumed, RI1+RI2<=maxRank is satisfied, where RI1 is reported RI in one CSI report of the two CSI reports, and RI2 is reported RI in another CSI report of the two CSI reports, and maxRank is configured by RRC signaling for the associated two CSI reportings or pre-defined as a specified value. When FDM or TDM scheme is assumed, RI1=RI2<=maxRank is satisfied, where RI1 is reported RI in one CSI report of the two CSI reports, and RI2 is reported RI in another CSI report of the two CSI reports, and maxRank is configured by RRC signaling for the associated two CSI reportings or pre-defined as a specified value.

In some embodiment, when SDM or FDM scheme is assumed, reported CRIs in the two CSI reports are the same, or only one CRI is included in one CSI report of the two CSI reports and also applies to another CSI report of the two CSI reports. When SDM, FDM or TDM scheme is assumed, reported CQIs in the two CSI reports are the same, or only one CQI is included in one CSI report of the two CSI reports and also applies to another CSI report of the two CSI reports.

In another embodiment, a remote unit comprises a receiver that receives a configuration indicating that two CSI reportings are associated with each other, and receives a DCI containing a CSI request field with a non-zero value that simultaneously triggers two CSI reports by associating the non-zero value to the associated two CSI reportings; and a transmitter that transmits the two CSI reports in a same slot.

In one embodiment, a method comprises transmitting a configuration indicating that two CSI reportings are associated with each other for multi-TRP scenario; transmitting a DCI containing a CSI request field with a non-zero value that simultaneously triggers two CSI reports by associating the non-zero value to the associated two CSI reportings; and receiving the two CSI reports in a same slot.

In yet another embodiment, a base unit comprises a transmitter that transmits a configuration indicating that two CSI reportings are associated with each other for multi-TRP scenario, and transmits a DCI containing a CSI request field with a non-zero value that simultaneously triggers two CSI reports by associating the non-zero value to the associated two CSI reportings; and a receiver that receives the two CSI reports in a same slot.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates an example of PDSCH transmission when SDM or FDM scheme is assumed;

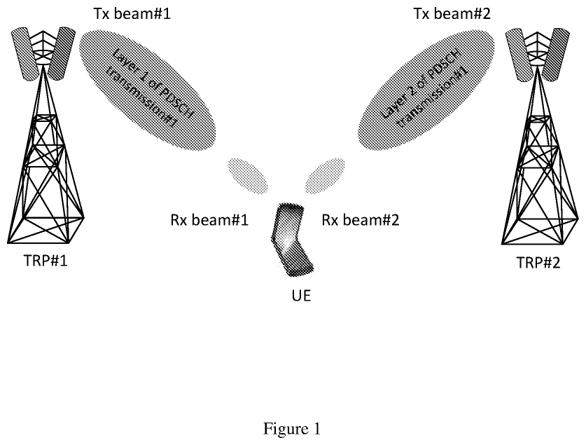

FIG. 2 illustrates an example of PDSCH transmission when TDM scheme is assumed;

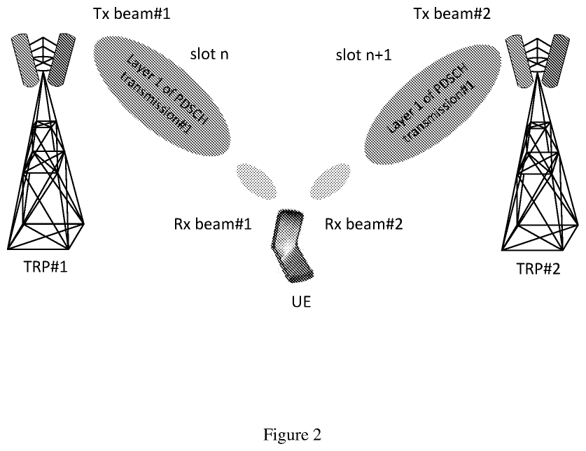

FIG. 3 illustrates a MAC CE format to associate two CSI reportings;

FIG. 4 illustrates an example of resource settings;

FIG. 5 is a schematic flow chart diagram illustrating an embodiment of a method;

FIG. 6 is a schematic flow chart diagram illustrating a further embodiment of a method; and

FIG. 7 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

It is assumed that TX beams with which single-DCI based multi-TRP PDSCH transmission is transmitted from different TRPs (e.g. TRP #1 and TRP #2) are paired by beam management procedure or additional CSI report procedure. In addition, it is assumed that the paired TX beams for single-DCI based multi-TRP PDSCH transmission for any of SDM, FDM and TDM schemes have been determined by the gNB.

One CSI report is used to report the quantities (parameters) for one TRP (e.g. TRP #1) in multi-TRP scenario according to one CSI reporting, and another CSI report is used to report the quantities (parameters) for another TRP (e.g. TRP #2) in multi-TRP scenario according to another CSI reporting. According to the present invention, the two CSI reportings (the one CSI reporting and the other CSI reporting) are configured by higher layer parameter CSI-ReportConfig IE with different CSI-ReportConfigIDs. Furthermore, the configured two CSI reportings are associated with each other. The association can be configured by RRC signaling.

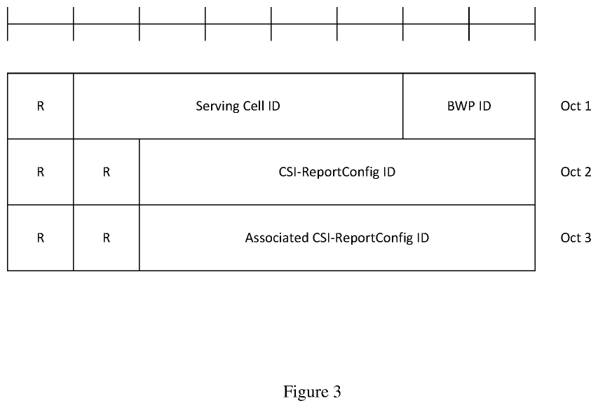

The association configured by RRC signaling can be updated by a MAC CE with an example format shown in FIG. 3. One CSI reporting identified by CSI-ReportConfig ID 0 (with 6 bits) and another CSI reporting identified by Associated CSI-ReportConfig ID (with 6 bits) are associated (updated to be associated) by the MAC CE shown in FIG. 3. The association applies to the BWP identified by BWP ID field (with 2 bits) of the serving cell identified by Serving Cell ID field (with 5 bits).

As the associated two CSI reportings are used for two CSI reports for two TRPs in single-DCI based multi-TRP PDSCH transmission, they are expected to have some configurations in common.

The associated two CSI reportings are expected to have the same aperiodic CSI triggering state, i.e., non-zero CSI request field value if aperiodic CSI report is configured. This means that the two CSI reports can be triggered by a same DCI containing a non-zero CSI request field value. In addition, the associated two CSI reportings are expected to have the same reporting slot offset for reporting aperiodic CSI. This means that the two CSI reports, when triggered, are reported in the same slot. The two CSI reports may be reported (transmitted) using (i.e. carried in) a same PUCCH or PUSCH resource.

The associated two CSI reportings are expected to have the same codebook configuration and the same codebook subset restriction, for uniform channel measurement and report.

The associated two CSI reportings are expected to have (linked to) the same number of CSI-RS resources within the resource setting for channel measurement (Channel Measurement Resource, CMR).

For different transmission schemes (i.e. SDM, FDM and TDM) for the associated two CSI reportings, different resource settings and different report settings are required to obtain the perfect CSI.

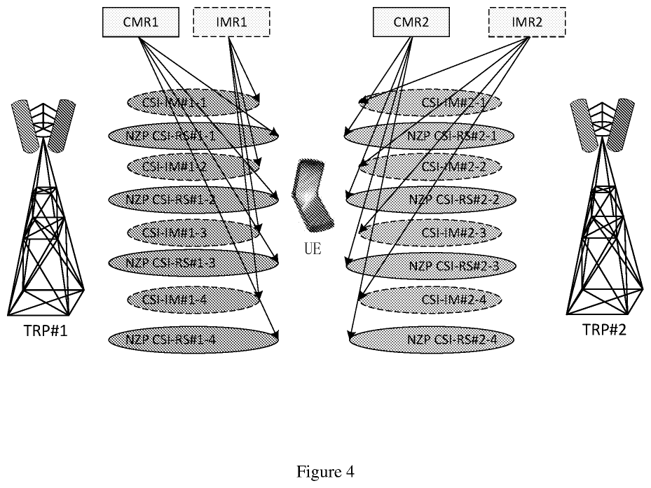

For ease of discussion, an example of resource settings is illustrated in FIG. 4. The resource settings shown in FIG. 4 can apply to CSI reportings with any of SDM, FDM and TDM schemes. A UE is served by both TRP #1 and TRP #2. Two CSI reportings with CSI-ReportConfig #1 and CSI-ReportConfig #2 are configured for the UE corresponding to TRP #1 and TRP #2. For ease of discussion, the CSI reporting with CSI-ReportConfig #1 is referred to as “first CSI reporting”, and the CSI reporting with CSI-ReportConfig #2 is referred to as “second CSI reporting”. The first CSI reporting and the second CSI reporting are configured to be associated with each other by RRC signaling (and can be updated by the MAC CE shown in FIG. 3). If both the first CSI reporting and the second CSI reporting are used for reporting aperiodic CSI, all CSI-RS resources within the CMR and IMR of the first CSI reporting and the second CSI reporting are associated with a same CSI-AperiodicTriggerState, i.e., they are associated with by a same non-zero CSI request field value. When a first CSI report and a second CSI report are triggered simultaneously by a DCI containing a CSI request field with a non-zero value by associating the non-zero value to the first CSI reporting and the second CSI reporting, the first CSI report and the second CSI report should be transmitted in a same slot.

NZP CSI-RS #1-1, NZP CSI-RS #1-2, NZP CSI-RS #1-3 and NZP CSI-RS #1-4 are CSI-RS resources for channel measurement (CMR) of the first CSI reporting (indicated as CMR1). CSI-IM #1-1, CSI-IM #1-2, CSI-IM #1-3 and CSI-IM #1-4 are CSI-RS resources for interference measurement (interference measurement resource, IMR) of the first CSI reporting (indicated as IMR1). Each CSI-RS for channel measurement is associated with a CSI-RS for interference measurement, i.e., NZP CSI-RS #1-1 is associated with CSI-IM #1-1, NZP CSI-RS #1-2 is associated with CSI-IM #1-2, NZP CSI-RS #1-3 is associated with CSI-IM #1-3, NZP CSI-RS #1-4 is associated with CSI-IM #1-4. All of NZP CSI-RS #1-1, NZP CSI-RS #1-2, NZP CSI-RS #1-3, NZP CSI-RS #1-4, CSI-IM #1-1, CSI-IM #1-2, CSI-IM #1-3 and CSI-IM #1-4 are transmitted from TRP #1 to UE.

NZP CSI-RS #2-1, NZP CSI-RS #2-2, NZP CSI-RS #2-3 and NZP CSI-RS #2-4 are CSI-RS resources for channel measurement (CMR) of the second CSI reporting (indicated as CMR2), and CSI-IM #2-1, CSI-IM #2-2, CSI-IM #2-3 and CSI-IM #2-4 are CSI-RS resources for interference measurement (IMR) of the second CSI reporting (indicated as IMR2). Each of NZP CSI-RS #2-1, NZP CSI-RS #2-2, NZP CSI-RS #2-3 and NZP CSI-RS #2-4 is associated respectively with each of CSI-IM #2-1, CSI-IM #2-2, CSI-IM #2-3 and CSI-IM #2-4. All of NZP CSI-RS #2-1, NZP CSI-RS #2-2, NZP CSI-RS #2-3, NZP CSI-RS #2-4, CSI-IM #2-1, CSI-IM #2-2, CSI-IM #2-3 and CSI-IM #2-4 are transmitted from TRP #2 to UE.

Each CSI-IM (each of CSI-IM #1-1, CSI-IM #1-2, CSI-IM #1-3, CSI-IM #1-4, CSI-IM #2-1, CSI-IM #2-2, CSI-IM #2-3 and CSI-IM #2-4) may be a NZP CSI-RS resource for NZP CSI-RS based interference measurement or a ZP CSI-RS resource for ZP CSI-RS based interference measurement.

For SDM or FDM scheme, the resource settings (including resource setting for channel measurement and resource setting for interference measurement) and the report settings may be configured as follows:

For channel measurement: NZP CSI-RS resources within CMR of the first CSI reporting (CMR1) are 1-to-1 associated with the NZP CSI-RS resources within the CMR of the second CSI reporting (CMR2). For example, as shown in FIG. 4, NZP CSI-RS #1-1, NZP CSI-RS #1-2, NZP CSI-RS #1-3 and NZP CSI-RS #1-4 are 1-to-1 associated respectively with NZP CSI-RS #2-1, NZP CSI-RS #2-2, NZP CSI-RS #2-3 and NZP CSI-RS #2-4. Each pair of associated NZP CSI-RS resources from two CMRs (CMR1 and CMR2) in the associated two CSI reportings (first CSI reporting and second CSI reporting) (e.g. associated NZP CSI-RS #1-1 and NZP CSI-RS #2-1, associated NZP CSI-RS #1-2 and NZP CSI-RS #2-2, . . . , etc.) may be configured on a same symbol with different QCL assumptions. In addition, each pair of associated NZP CSI-RS resources may be simultaneously received by the UE. For example, when SDM scheme is assumed, NZP CSI-RS #1-1 is associated with NZP CSI-RS #2-1 to become a pair of associated NZP CSI-RS resources and they can be simultaneously received by UE, NZP CSI-RS #1-2 is associated with NZP CSI-RS #2-2 to become a pair of associated NZP CSI-RS resources and they can be simultaneously received by UE, NZP CSI-RS #1-3 is associated with NZP CSI-RS #2-3 to become a pair of associated NZP CSI-RS resources and they can be simultaneously received by UE, and NZP CSI-RS #1-4 is associated with NZP CSI-RS #2-4 to become a pair of associated NZP CSI-RS resources and they can be simultaneously received by UE.

For interference measurement: If NZP CSI-RS based interference measurement is configured for the associated two CSI reportings, NZP-CSI-RS resources within IMRs in the associated two CSI reportings should be considered in the interference calculation in each of the two CSI reports. For example, as shown in FIG. 4, CSI-IM #1-1 and CSI-IM #2-1 (that are configured as NZP-CSI-RS resources if NZP CSI-RS based interference measurement is configured) and other interference signal on REs of NZP CSI-RS #1-1 are the interference for NZP CSI-RS #1-1. If ZP CSI-RS based interference measurement is configured for the associated two CSI reportings, the same ZP CSI-RS pattern is expected to be configured for the associated two CSI reportings for inter-cell interference measurement for CSI-RS overhead reduction. According to different UE capabilities and different schemes (SDM or FDM), the interference between a pair of associated NZP CSI-RS resources may be configured to be reflected or not reflected in the reported CSI. For SDM scheme, the interference between a pair of associated NZP CSI-RS resources may be not treated as part of interference for the UE with interference suppression capability, and may be treated as part of interference for the UE without interference suppression capability. For example, if the UE has the interference suppression capability, the interference conducted on NZP CSI-RS #2-1 is not considered as part of the other interference signal on REs of NZP CSI-RS #1-1 (i.e. it is subtracted from the other interference signal on REs of NZP CSI-RS #1-1); while if the UE does not have the interference suppression capability, the interference conducted on NZP CSI-RS #2-1 is considered as part of the other interference signal on REs of NZP CSI-RS #1-1. For FDM scheme, the interference between a pair of associated NZP CSI-RS resources is not treated as part of interference since they are transmitted on different RBs.

For report settings: similar to the prior art, the CSI parameters (quantities) to be reported depend on the RRC parameter ‘reportQuantity’ contained in the ‘CSI-ReportConfig’. For example, when ‘reportQuantity’ in the ‘CSI-ReportConfig’ is set to cri-RI-PMI-CQI′, CRI, RI, PMI and CQI may be included in each of the first CSI report and the second CSI report. The reported quantities can be configured as follows:

For CRI: The reported CRIs for the associated two CSI reportings (i.e. included in the two CSI reports) should be the same if CRI is required to be included in both the first CSI report and the second CSI report. Alternatively, CRI can be only included in one CSI report (the first CSI report or the second CSI report) and also apply to the other CSI report (the second CSI report or the first CSI report).

For RI: the configurations of RI are different for SDM and FDM schemes. For SDM scheme, RI1+RI2<=maxRank. For FDM scheme, RI1=RI2<=maxRank. RI1 is the RI value for the first CSI reporting (included in the first CSI report), and RI2 is the RI value for the second CSI reporting (included in the second CSI report). The maxRank can be configured by RRC signaling for the associated two CSI reportings. For example, maxRank may be configured as 4 if NR Release 16 SDM or FDM Scheme is assumed. The maxRank can be alternatively predefined as other specified value different from 4.

For PMI: PMIs are included separately in the first CSI report and in the second CSI report.

For CQI: A same CQI is expected for both the first CSI reporting and the second CSI reporting (included in both the first CSI report and the second CSI report). Alternatively, CQI can be only included in one CSI report (the first CSI report or the second CSI report) and also apply to the other CSI report (the second CSI report or the first CSI report).

For TDM scheme, the resource settings (including resource setting for channel measurement and resource setting for interference measurement) and the report settings are configured as follows:

For channel measurement and interference measurement: the NR Release 16 channel measurement and interference measurement behaviors apply to the associated two CSI reportings (and the two CSI reports).

For report settings: the report quantities can be configured as follows:

For CRI: different CRIs may be included in the first CSI report and in the second CSI report.

For RI: RI1=RI2<=maxRank. RI1 is the RI value for the first CSI reporting (included in the first CSI report), and RI2 is the RI value for the second CSI reporting (included in the second CSI report). The maxRank can be configured by RRC signaling for the associated two CSI reportings. For example, maxRank may be configured as 4 if NR Release 16 TDM scheme is assumed. The maxRank can be alternatively predefined as other specified value different from 4.

For PMI: PMIs are included separately in the first CSI report and in the second CSI report.

For CQI: A same CQI is expected for both the first CSI reporting and the second CSI reporting (included in both the first CSI report and the second CSI report). Alternatively, CQI can be only included in one CSI report (the first CSI report or the second CSI report) and also apply to the other CSI report (the second CSI report or the first CSI report).

The first CSI report and the second CSI report include respectively the parameters (quantities) for TRP #1 and TRP #2. As described above, some of the parameters (quantities) are highly correlated. For example, the CRIs for the associated two CSI reportings (included in the two CSI reports) should be the same for SDM and FDM schemes, which implies that the CRI only needs to be included in either the first CSI report (for TRP #1) or the second CSI report (for TRP #2). In addition, the CQIs for the associated two CSI reportings (included in the two CSI reports) should be the same for SDM, FDM and TDM schemes, which implies that the CQI only needs to be included in either the first CSI report (for TRP #1) or the second CSI report (for TRP #2). Based on this assumption, an example of CSI report format is provided as follows:

The first CSI Report (for TRP#1):= {

| | |
|---|---|
| • | CRI#1 (indicating a CSI-RS resource for channel measurement in the first CSI report, |
| | and implicitly indicating the corresponding CSI-RS resource for channel measurement |
| | (i.e. CRI#2) in the second CSI report) |
| • | RI#1 (transmission rank used by CRI#1) |
| • | PMI#1 |

}
The second CSI report (for TRP#2):= {

| | |
|---|---|
| • | RI#2 (transmission rank used by CRI#2) |
| • | PMI#2 |
| • | CQI (indicating a CQI applying to both the first CSI report and the second CSI report) |

}

If the above example is used for SDM scheme, CQI is calculated based on the CSI-RS resources indicated by CRI in both CSI reports (or in the CSI report that includes CRI) using the precoding matrix indicated by PMI #1 and PMI #2 with total RI=RI1+RI2. If the above example is used for FDM scheme, CQI can be the average CQIs calculated on the CSI-RS resources indicated by CRI using the precoding matrix indicated by PMI #1 and PMI #2 with RI #1 or RI #2.

All quantities (parameters) included in the first CSI report and the second CSI report can be transmitted (carried) in a same PUCCH or PUSCH resource. In other words, the first CSI report and the second CSI report can be transmitted (carried) in a same PUCCH or PUSCH resource.

Traditionally, when K CSI-RS resources are configured within the resource setting for channel measurement in a CSI reporting, a total of K CPUs (CSI process units) is occupied for CSI calculation. So, the CSI calculation for two CSI reportings, each of which includes K CSI-RS resources within the resource setting for channel measurement, would occupy 2*K CPUs. According to the present invention, when K CSI-RS resources are configured within the resource setting for channel measurement in both associated two CSI reportings, a total of K CPUs (CSI process units) are still occupied by the associated two CSI reportings for CSI calculation. The K CPUs are occupied from the slot receiving the DCI (triggering the two CSI reports) to the slot transmitting the PUCCH or PUSCH resource carrying the two CSI reports. In the example of FIG. 4, each of the associated two CSI reportings includes 4 NZP CSI-RS resources within the resource setting for channel measurement. So, 4 CPUs are occupied by the two CSI reports.

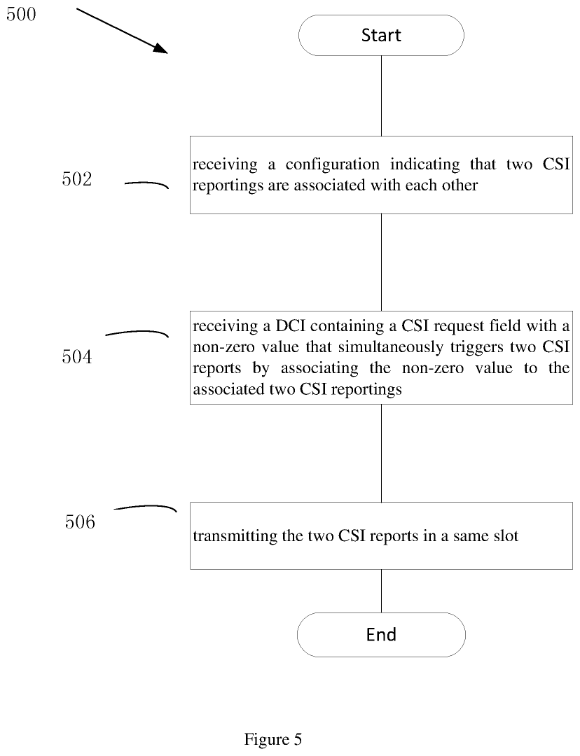

FIG. 5 is a schematic flow chart diagram illustrating an embodiment of a method 500 according to the present application. In some embodiments, the method 500 is performed by an apparatus, such as a remote unit. In certain embodiments, the method 500 may be performed by a processor executing program code, for example, a microcontroller, a microprocessor, a CPU, a GPU, an auxiliary processing unit, a FPGA, or the like.

The method 500 may include 502 receiving a configuration indicating that two CSI reportings are associated with each other; 504 receiving a DCI containing a CSI request field with a non-zero value that simultaneously triggers two CSI reports by associating the non-zero value to the associated two CSI reportings; and 506 transmitting the two CSI reports in a same slot.

In the method 500, the configuration may be received by RRC signaling or by a MAC CE. Preferably, the same codebook configuration and the same codebook subset restriction are configured for the associated two CSI reportings. When K CSI-RS resources are configured within a resource setting for channel measurement of each of the associated two CSI reportings, K CPUs are occupied by the two CSI reports from a slot receiving the DCI to the same slot transmitting a PUCCH or PUSCH resource carrying the two CSI reports.

In the method 500, each of NZP CSI-RS resources within a resource setting for channel measurement of one CSI reporting in the associated two CSI reportings are 1-to-1 associated with each of NZP CSI-RS resources within a resource setting for channel measurement of another CSI reporting in the associated two CSI reportings, and the associated NZP CSI-RS resources can be simultaneously received in a same symbol when SDM or FDM scheme is assumed. If NZP CSI-RS based interference measurement is configured for the associated two CSI reportings, NZP-CSI-RS resources within resource settings for interference measurement of the associated two CSI reportings associated with the paired NZP CSI-RS resources for channel measurement are considered in the interference calculation in each of the two CSI reports. If ZP CSI-RS based interference measurement is configured for the associated two CSI reportings, the same ZP CSI-RS pattern is configured for the associated two CSI reportings. When SDM scheme is assumed, the interference between associated NZP CSI-RS resources for channel measurement is not considered as the interference for UE with interference suppression capability, and is considered as the interference for UE without interference suppression capability. When FDM scheme is assumed, the interference between associated NZP CSI-RS resources is not considered as the interference for UE.

In the method 500, when SDM scheme is assumed, RI1+RI2<=maxRank is satisfied, where RI1 is reported RI in one CSI report of the two CSI reports, and RI2 is reported RI in another CSI report of the two CSI reports, and maxRank is configured by RRC signaling for the associated two CSI reportings or pre-defined as a specified value.

In the method 500, when FDM or TDM scheme is assumed, RI1=RI2<=maxRank is satisfied, where RI1 is reported RI in one CSI report of the two CSI reports, and RI2 is reported RI in another CSI report of the two CSI reports, and maxRank is configured by RRC signaling for the associated two CSI reportings or pre-defined as a specified value.

In the method 500, when SDM or FDM scheme is assumed, reported CRIs in the two CSI reports are the same, or only one CRI is included in one CSI report of the two CSI reports and also applies to another CSI report of the two CSI reports.

In the method 500, when SDM, FDM or TDM scheme is assumed, reported CQIs in the two CSI reports are the same, or only one CQI is included in one CSI report of the two CSI reports and also applies to another CSI report of the two CSI reports.

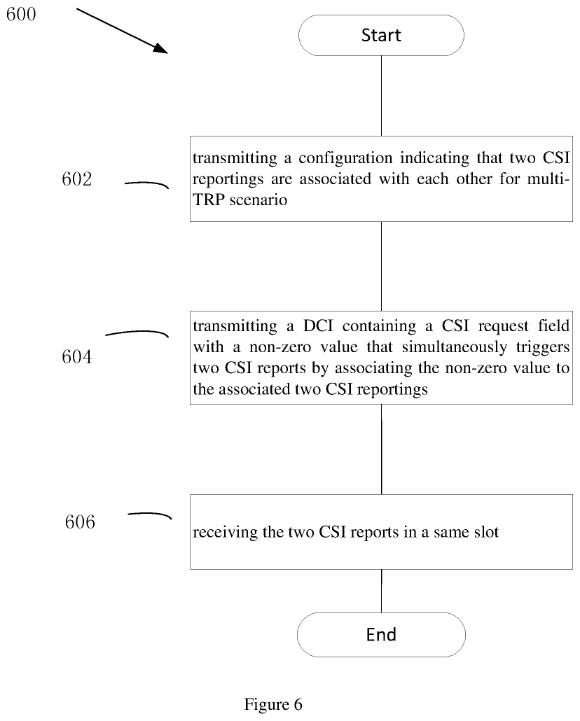

FIG. 6 is a schematic flow chart diagram illustrating an embodiment of a method 600 according to the present application. In some embodiments, the method 600 is performed by an apparatus, such as a base unit. In certain embodiments, the method 600 may be performed by a processor executing program code, for example, a microcontroller, a microprocessor, a CPU, a GPU, an auxiliary processing unit, a FPGA, or the like.

The method 600 may include 602 transmitting a configuration indicating that two CSI reportings are associated with each other for multi-TRP scenario; 604 transmitting a DCI containing a CSI request field with a non-zero value that simultaneously triggers two CSI reports by associating the non-zero value to the associated two CSI reportings; and 606 receiving the two CSI reports in a same slot.

In the method 600, the configuration may be transmitted by RRC signaling or by a MAC CE. Preferably, the same codebook configuration and the same codebook subset restriction are configured for the associated two CSI reportings.

In the method 600, each of NZP CSI-RS resources within a resource setting for channel measurement of one CSI reporting in the associated two CSI reportings are 1-to-1 associated with each of NZP CSI-RS resources within a resource setting for channel measurement of another CSI reporting in the associated two CSI reportings, and the associated NZP CSI-RS resources can be simultaneously transmitted in a same symbol when SDM or FDM scheme is assumed. If NZP CSI-RS based interference measurement is configured for the associated two CSI reportings, NZP-CSI-RS resources within resource settings for interference measurement of the associated two CSI reportings associated with the paired NZP CSI-RS resources for channel measurement are considered in the interference calculation in each of the two CSI reports. If ZP CSI-RS based interference measurement is configured for the associated two CSI reportings, the same ZP CSI-RS pattern is configured for the associated two CSI reportings. When SDM scheme is assumed, the interference between associated NZP CSI-RS resources for channel measurement is not considered as the interference for UE with interference suppression capability, and is considered as the interference for UE without interference suppression capability. When FDM scheme is assumed, the interference between associated NZP CSI-RS resources is not considered as the interference for UE.

In the method 600, when SDM scheme is assumed, RI1+RI2<=maxRank is satisfied, where RI1 is reported RI in one CSI report of the two CSI reports, and RI2 is reported RI in another CSI report of the two CSI reports, and maxRank is configured by RRC signaling for the associated two CSI reportings or pre-defined as a specified value.

In the method 600, when FDM or TDM scheme is assumed, RI1=RI2<=maxRank is satisfied, where RI1 is reported RI in one CSI report of the two CSI reports, and RI2 is reported RI in another CSI report of the two CSI reports, and maxRank is configured by RRC signaling for the associated two CSI reportings or pre-defined as a specified value.

In the method 600, when SDM or FDM scheme is assumed, reported CRIs in the two CSI reports are the same, or only one CRI is included in one CSI report of the two CSI reports and also applies to another CSI report of the two CSI reports.

In the method 600, when SDM, FDM or TDM scheme is assumed, reported CQIs in the two CSI reports are the same, or only one CQI is included in one CSI report of the two CSI reports and also applies to another CSI report of the two CSI reports.

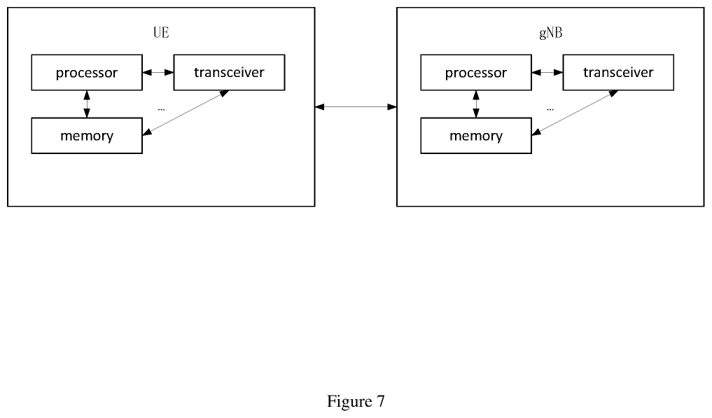

FIG. 7 is a schematic block diagram illustrating apparatuses according to one embodiment.

Referring to FIG. 7, the UE (i.e. the remote unit) includes a processor, a memory, and a transceiver. The processor implements a function, a process, and/or a method which are proposed in FIG. 5.

The remote unit comprises a receiver that receives a configuration indicating that two CSI reportings are associated with each other, and receives a DCI containing a CSI request field with a non-zero value that simultaneously triggers two CSI reports by associating the non-zero value to the associated two CSI reportings; and a transmitter that transmits the two CSI reports in a same slot.

With respect to the remote unit, the receiver may receive the configuration by RRC signaling or by a MAC CE. Preferably, the same codebook configuration and the same codebook subset restriction are configured for the associated two CSI reportings. When K CSI-RS resources are configured within a resource setting for channel measurement of each of the associated two CSI reportings, K CPUs are occupied in the remote unit by the two CSI reports from a slot receiving the DCI to the same slot transmitting a PUCCH or PUSCH resource carrying the two CSI reports.

With respect to the remote unit, each of NZP CSI-RS resources within a resource setting for channel measurement of one CSI reporting in the associated two CSI reportings are 1-to-1 associated with each of NZP CSI-RS resources within a resource setting for channel measurement of another CSI reporting in the associated two CSI reportings, and the receiver can receive the associated NZP CSI-RS resources simultaneously in a same symbol when SDM or FDM scheme is assumed. If NZP CSI-RS based interference measurement is configured for the associated two CSI reportings, NZP-CSI-RS resources within resource settings for interference measurement of the associated two CSI reportings associated with the paired NZP CSI-RS resources for channel measurement are considered in the interference calculation in each of the two CSI reports. If ZP CSI-RS based interference measurement is configured for the associated two CSI reportings, the same ZP CSI-RS pattern is configured for the associated two CSI reportings. When SDM scheme is assumed, the interference between associated NZP CSI-RS resources for channel measurement is not considered as the interference for the remote unit with interference suppression capability, and is considered as the interference for the remote unit without interference suppression capability. When FDM scheme is assumed, the interference between associated NZP CSI-RS resources is not considered as the interference for the remote unit.

With respect to the remote unit, when SDM scheme is assumed, RI1+RI2<=maxRank is satisfied, where RI1 is reported RI in one CSI report of the two CSI reports, and RI2 is reported RI in another CSI report of the two CSI reports, and maxRank is configured by RRC signaling for the associated two CSI reportings or pre-defined as a specified value.

With respect to the remote unit, when FDM or TDM scheme is assumed, RI1=RI2<=maxRank is satisfied, where RI1 is reported RI in one CSI report of the two CSI reports, and RI2 is reported RI in another CSI report of the two CSI reports, and maxRank is configured by RRC signaling for the associated two CSI reportings or pre-defined as a specified value.

With respect to the remote unit, when SDM or FDM scheme is assumed, reported CRIs in the two CSI reports are the same, or one CRI is included in one CSI report of the two CSI reports and also applies to another CSI report of the two CSI reports.

With respect to the remote unit, when SDM, FDM or TDM scheme is assumed, reported CQIs in the two CSI reports are the same, or only one CQI is included in one CSI report of the two CSI reports and also applies to another CSI report of the two CSI reports.

The gNB (i.e. base unit) includes a processor, a memory, and a transceiver. The processors implement a function, a process, and/or a method which are proposed in FIG. 6.

The base unit comprises a transmitter that transmits a configuration indicating that two CSI reportings are associated with each other for multi-TRP scenario, and transmits a DCI containing a CSI request field with a non-zero value that simultaneously triggers two CSI reports by associating the non-zero value to the associated two CSI reportings; and a receiver that receives the two CSI reports in a same slot.

With respect to the base unit, the transmitter may transmit the configuration by RRC signaling or by a MAC CE. Preferably, the same codebook configuration and the same codebook subset restriction are configured for the associated two CSI reportings.

With respect to the base unit, each of NZP CSI-RS resources within a resource setting for channel measurement of one CSI reporting in the associated two CSI reportings are 1-to-1 associated with each of NZP CSI-RS resources within a resource setting for channel measurement of another CSI reporting in the associated two CSI reportings, and the transmitter transmits the associated NZP CSI-RS resources simultaneously in a same symbol when SDM or FDM scheme is assumed. If NZP CSI-RS based interference measurement is configured for the associated two CSI reportings, NZP-CSI-RS resources within resource settings for interference measurement of the associated two CSI reportings associated with the paired NZP CSI-RS resources for channel measurement are considered in the interference calculation in each of the two CSI reports. If ZP CSI-RS based interference measurement is configured for the associated two CSI reportings, the same ZP CSI-RS pattern is configured for the associated two CSI reportings. When SDM scheme is assumed, the interference between associated NZP CSI-RS resources for channel measurement is not considered as the interference for UE with interference suppression capability, and is considered as the interference for UE without interference suppression capability. When FDM scheme is assumed, the interference between associated NZP CSI-RS resources is not considered as the interference for UE.

With respect to the base unit, when SDM scheme is assumed, RI1+RI2<=maxRank is satisfied, where RD is reported RI in one CSI report of the two CSI reports, and RI2 is reported RI in another CSI report of the two CSI reports, and maxRank is configured by RRC signaling for the associated two CSI reportings or pre-defined as a specified value.

With respect to the base unit, when FDM or TDM scheme is assumed, RI1=RI2<=maxRank is satisfied, where RD is reported RI in one CSI report of the two CSI reports, and RI2 is reported RI in another CSI report of the two CSI reports, and maxRank is configured by RRC signaling for the associated two CSI reportings or pre-defined as a specified value.

With respect to the base unit, when SDM or FDM scheme is assumed, reported CRIs for the two CSI reports are the same, or only one CRI is included in one CSI report of the two CSI reports and also applies to another CSI report of the two CSI reports.

With respect to the base unit, when SDM, FDM or TDM scheme is assumed, reported CQIs in the two CSI reports are the same, or only one CQI is included in one CSI report of the two CSI reports and also applies to another CSI report of the two CSI reports.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A remote unit, comprising:
a receiver that receives a configuration indicating that two channel state information (CSI) reportings are associated with each other and
a downlink control information (DCI) containing a CSI request field with a non-zero value that simultaneously triggers two CSI reports by associating the non-zero value to the associated two CSI reportings; and
a transmitter that transmits the two CSI reports in a same slot.

2. The remote unit of claim 1, wherein, the configuration is received by radio resource control (RRC) signaling or by a medium access channel contrl element (MAC CE).

3. The remote unit of claim 1, wherein, the same codebook configuration and the same codebook subset restriction are configured for the associated two CSI reportings.

4. The remote unit of claim 1, wherein, when K CSI reference signal (CSI-RS) resources are configured within a resource setting for channel measurement of each of the associated two CSI reportings, K central processing units (CPUs) are occupied by the two CSI reports from a slot receiving the DCI to the same slot transmitting a physical uplink control channel (PUCCH) or physical uplink shared channel (PUSCH) resource carrying the two CSI reports.

5. The remote unit of claim 1, wherein, each of Non-Zero Power (NZP) CSI reference signal (CSI-RS) resources within a resource setting for channel measurement of one CSI reporting in the associated two CSI reportings are 1-to-1 associated with each of NZP CSI-RS resources within a resource setting for channel measurement of another CSI reporting in the associated two CSI reportings, and the associated NZP CSI-RS resources can be simultaneously received in a same symbol when Space Division Multiplexing (SDM) or Frequency Division Multiplexing (FDM) scheme is assumed.

6. The remote unit of claim 5, wherein, if NZP CSI-RS based interference measurement is configured for the associated two CSI reportings, NZP-CSI-RS resources within resource settings for interference measurement of the associated two CSI reportings associated with the paired NZP CSI-RS resources for channel measurement are considered in the interference calculation in each of the two CSI reports, and if ZP CSI-RS based interference measurement is configured for the associated two CSI reportings, the same ZP CSI-RS pattern is configured for the associated two CSI reportings.

7. The remote unit of claim 5, wherein, when SDM scheme is assumed, the interference between associated NZP CSI-RS resources for channel measurement is not considered as the interference for UE with interference suppression capability, and is considered as the interference for UE without interference suppression capability.

8. The remote unit of claim 5, wherein, when FDM scheme is assumed, the interference between associated NZP CSI-RS resources is not considered as the interference for UE.

9. The remote unit of claim 1, wherein, when Space Division Multiplexing (SDM) scheme is assumed, RI1+RI2<=maxRank is satisfied, where RI1 is reported RI in one CSI report of the two CSI reports, and RI2 is reported RI in another CSI report of the two CSI reports, and maxRank is configured by radio resource control (RRC) signaling for the associated two CSI reportings or pre-defined as a specified value.

10. The remote unit of claim 1, wherein, when Frequency Division Multiplexing (FDM) or Time Division Multiplexing (TDM) scheme is assumed, RI1=RI2<=maxRank is satisfied, where RI1 is reported RI in one CSI report of the two CSI reports, and RI2 is reported RI in another CSI report of the two CSI reports, and maxRank is configured by radio resource control (RRC) signaling for the associated two CSI reportings or pre-defined as a specified value.

11. The remote unit of claim 1, wherein, when Space Division Multiplexing (SDM) or Frequency Multiplexing (FDM) scheme is assumed, reported CSI Reference Signal Resource Indicators (CRIs) in the two CSI reports are the same, or only one CRI is included in one CSI report of the two CSI reports and also applies to another CSI report of the two CSI reports.

12. The remote unit of claim 1, wherein, when Space Division Multiplexing (SDM), Frequency Division Multiplexing (FDM) or Time Division Multiplexing (TDM) scheme is assumed, reported Channel Quality Indicators (CQIs) in the two CSI reports are the same, or only one CQI is included in one CSI report of the two CSI reports and also applies to another CSI report of the two CSI reports.

13. (canceled)

14. (canceled)

15. A base unit, comprising:
a transmitter that transmits a configuration indicating that two channel state information (CSI) reportings are associated with each other for multiple transmission reception point (multi-TRP) scenario, and transmits a downlink control information (DCI) containing a CSI request field with a non-zero value that simultaneously triggers two CSI reports by associating the non-zero value to the associated two CSI reportings; and
a receiver that receives the two CSI reports in a same slot.

16. A method, comprising:
receiving a configuration indicating that two channel state information (CSI) reportings are associated with each other;
receiving a downlink control information (DCI) containing a CSI request field with a non-zero value that simultaneously triggers two CSI reports by associating the non-zero value to the associated two CSI reportings; and
transmitting the two CSI reports in a same slot.

17. The method of claim 16, wherein the configuration is received by radio resource control (RRC) signaling or by a medium access channel contrl element (MAC CE).

18. The method of claim 16, wherein the same codebook configuration and the same codebook subset restriction are configured for the associated two CSI reportings.

19. The method of claim 16, wherein when K CSI reference signal (CSI-RS) resources are configured within a resource setting for channel measurement of each of the associated two CSI reportings, K central processing units (CPUs) are occupied by the two CSI reports from a slot receiving the DCI to the same slot transmitting a physical uplink control channel (PUCCH) or physical uplink shared channel (PUSCH) resource carrying the two CSI reports.

20. The method of claim 16, wherein each of Non-Zero Power (NZP) CSI reference signal (CSI-RS) resources within a resource setting for channel measurement of one CSI reporting in the associated two CSI reportings are 1-to-1 associated with each of NZP CSI-RS resources within a resource setting for channel measurement of another CSI reporting in the associated two CSI reportings, and the associated NZP CSI-RS resources can be simultaneously received in a same symbol when Space Division Multiplexing (SDM) or Frequency Division Multiplexing (FDM) scheme is assumed.

21. The method of claim 16, wherein, when Frequency Division Multiplexing (FDM) or Time Division Multiplexing (TDM) scheme is assumed, RI1=RI2<=maxRank is satisfied, where RI1 is reported RI in one CSI report of the two CSI reports, and RI2 is reported RI in another CSI report of the two CSI reports, and maxRank is configured by radio resource control (RRC) signaling for the associated two CSI reportings or pre-defined as a specified value.

22. The method of claim 16, wherein, when Frequency Division Multiplexing (FDM) or Time Division Multiplexing (TDM) scheme is assumed, RI1=RI2<=maxRank is satisfied, where RI1 is reported RI in one CSI report of the two CSI reports, and RI2 is reported RI in another CSI report of the two CSI reports, and maxRank is configured by radio resource control (RRC) signaling for the associated two CSI reportings or pre-defined as a specified value.
